(19) United States
(12) Patent Application Publication
(10) Pub. No.: US 2007/0198776 A1
(43) Pub. Date: Aug. 23, 2007

(54) OPTICAL DISC DRIVE CONTROLLING SYSTEM

(76) Inventor: Guo-Zhan Zhuang, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 11/675,623

(22) Filed: Feb. 15, 2007

(30) Foreign Application Priority Data
Feb. 21, 2006 (TW) 095105787

(51) Int. Cl. G06F 13/00

(52) U.S. Cl. 711/113

(57) ABSTRACT

The present invention discloses an optical disc drive controlling system. The system includes: a first memory for storing at least a program code; and a control circuit for controlling operation of the optical disc drive controlling system. The control circuit includes: a communication interface coupled to the first memory for accessing the first memory; and a second memory coupled to the control circuit; wherein before storing the program code read from the first memory into the second memory, the control circuit transmits or receives signals which are only related to the operation of the first memory through the communication interface, and after storing the program code read from the first memory into the second memory, the control circuit transmits or outputs signals which are not related to the operation of the first memory through the communication interface.

### BACKGROUND OF THE INVENTION

1. Field of the Invention

The present invention relates to optical disc drive controlling systems, and more particularly to a controlling system that utilizes general purpose pins of a control device from the optical disc drive.

2. Description of the Prior Art

Please refer to FIG. 1. FIG. 1 is a diagram illustrating an optical disc drive controlling system 100 according to the prior art. The optical disc drive controlling system 100 comprises a control device 110 for executing firmware program code to control the operation of the optical disc. The control device 110 comprises a plurality of pins, where the pins are regarded as the communication interface between control device 110, other control circuits, or devices. A portion of the pins of the control device 110 are utilized for receiving the reference voltage VCC and GND, while others are utilized to connect between a flash memory 120, a dynamic random access memory 130, a motor driver 140, a pre-amplifier 150, or are utilized to output an IDE signal, digital/analog audio signals, or are utilized as general input/output pins. The motor driver 140 is utilized for controlling a motor system 145 in the optical disc drive to rotate the optical disc (not shown), the pre-amplifier 150 is utilized for receiving the signal read from the optical disc by a read/write head 155 and the amplified signal is then transmitted to the control device 110.

The firmware program code of the optical disc drive controlling system 100 is stored in the flash memory 120. When the control device 110 is ready to execute the firmware program code, the control device 110 first reads the firmware program code from the flash memory 120 and registers the firmware program code into the faster dynamic random access memory 130. Then, the control device 110 executes the firmware program code in the dynamic random access memory 130. After the firmware program code is read from flash memory 120, the communication interface between the control device 110 and the flash memory 120, which includes the pins for connecting the flash memory 120, is not used. Idleness of the pins increases the cost of control device 110.

### SUMMARY OF THE INVENTION

An objective of the present invention is to provide an optical disc drive controlling system to solve the above-mentioned problem.

According to an embodiment of the present invention, an optical disc drive controlling system is disclosed. The optical disc drive controlling system includes: a first memory for storing a program code; and a control circuit for controlling operation of the optical disc drive controlling system. The control circuit includes: a communication interface coupled to the first memory for accessing the first memory; and a second memory coupled to the control circuit; wherein before storing the program code read from the first memory into the second memory, the control circuit transmits or receives signals which are only related to the operation of the first memory through the communication interface; and after storing the program code read from the first memory into the second memory, the control circuit transmits or outputs signals which are not related to the operation of the first memory through the communication interface.

According to another embodiment of the present invention, an optical disc drive controlling system is disclosed. The optical disc drive controlling system includes: a first memory for storing a program code; a control circuit for controlling operation of the optical disc drive controlling system. The control circuit includes: a communication interface coupled to the first memory for accessing the first memory; and a second memory coupled to the communication interface; wherein after storing the program code read from the first memory into the second memory, the control circuit transmits or outputs signals which are related only to the operation of the second memory through the communication interface.

According to another embodiment of the present invention, an optical disc drive controlling method is disclosed. The method includes: providing a control device with at least a pin; providing a non-volatile memory, the non-volatile memory storing a program code and coupled to the control device through the pin; providing a first logic circuit, coupled to the control device through the pin; transmitting at least a first signal between the control device and the non-volatile memory through the pin to read the program code stored in the non-volatile memory; and transmitting at least a second signal between the control device and the first logic circuit through the pin after reading the program code.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional optical disc drive controlling system.

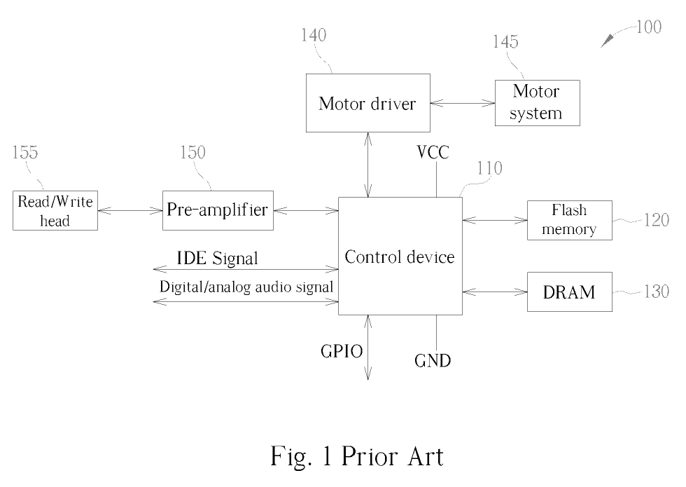

FIG. 2 is a diagram illustrating a first embodiment of the optical disc drive controlling system according to the present invention.

FIG. 3 is a diagram illustrating a second embodiment of the optical disc drive controlling system according to the present invention.

FIG. 4 illustrates a third embodiment of the optical disc drive controlling system according to the present invention.

FIG. 5 illustrates a fourth embodiment of the optical disc drive controlling system according to the present invention.

### DETAILED DESCRIPTION

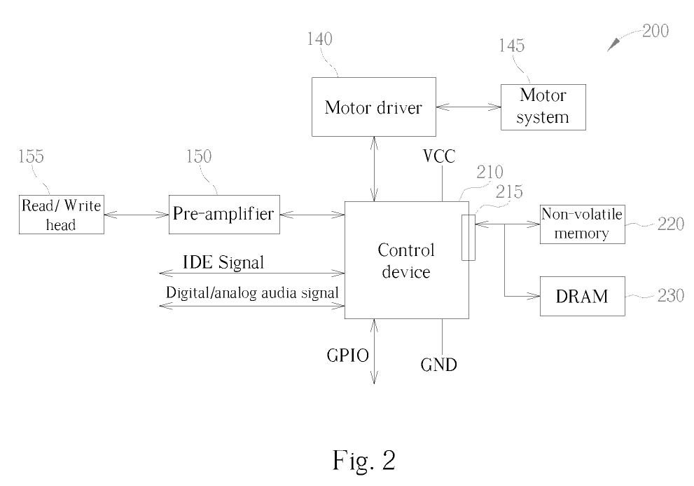

Please refer to FIG. 2. FIG. 2 is a diagram illustrating a first embodiment of an optical disc drive controlling system 200 according to the present invention. The optical disc drive controlling system 200 includes a control device 210, a non-volatile memory (flash memory as an example in the following description) 220, a dynamic random access memory 230, a motor driver 140, a motor system 145, a pre-amplifier 150, and a read/write head 155. Other pins of the control device 210 are capable of outputting an IDE signal, digital/analog audio signals, or are utilized as general pins. The non-volatile memory 220 and the dynamic random access memory 230 are coupled to the control device 210 through a communication interface 215 of control device 210, meaning that the non-volatile memory 220 and the dynamic random access memory 230 share a portion of the pins (the communication interface 215) of the control device 210. When the optical disc drive controlling system 200 is activated, the control device 210 reads the firmware program code of the system from the flash memory 220 through the communications interface 215, and writes the firmware program code into the dynamic random access memory 230. After the optical disc drive controlling system 200 completes the shifting of the firmware program code, the control device 210 stops accessing the flash memory 220. Then, the communications interface 215 is utilized to transmit or receive signals related to the operation of the dynamic random access memory 230 only. In other words, the flash memory 220 and the dynamic random access memory 230 utilize the common pins of control device 210. Therefore, some pins of the control device 210 can be saved in order to reduce system costs. Furthermore, the control device 210 additionally includes a cache memory (not shown). When the control device 210 executes the firmware program code stored in the dynamic random access memory 230, the cache memory can register a portion of the firmware program code to speed up operation of the optical disc drive controlling system 200.

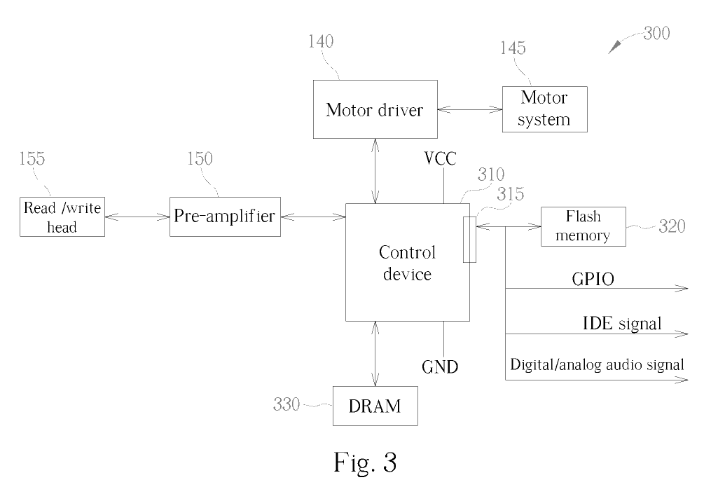

Please refer to FIG. 3. FIG. 3 is a diagram illustrating a second embodiment of the optical disc drive controlling system 300 according to the present invention. The optical disc drive controlling system 300 shown in FIG. 3 is similar to optical disc drive controlling system 200, except that the flash memory 320 and the dynamic random access memory 330 do not utilize a communications interface 315 of control device 310. Furthermore, before the control device 310 reads the firmware program code from the flash memory 320 and writes the firmware program code into the dynamic random access memory 330, the control device 310 transmits and receives only the signal related to operation of the flash memory 320 through the communication interface 315. After the control device 310 completes writing the firmware program code read from the flash memory 320 into the dynamic random access memory 330, the control device 310 utilizes the communications interface 315 to transmit digital/analog audio signals, IDE signals, or utilizes the communication interface 315 as a general input/output port. The digital/analog audio signals, IDE signals, or the signals transmitted/received by the general input/output port are not related to the operation of the flash memory 320. In other words, when the optical disc drive controlling system 300 is activated, the communication interface 315 is idling after the control device 310 completes accessing the flash memory 320. Then, the control device 310 utilizes pins not used (in the communication interface 315) to transmit and receive data signals or control signals for reducing the system cost. Similarly, the control device 310 further comprises a cache memory (not shown). When the control device 310 executes the firmware program code stored in the dynamic random access memory 330, the cache memory can register a portion of the firmware program code that can speed up the operation of the optical disc drive controlling system 300.

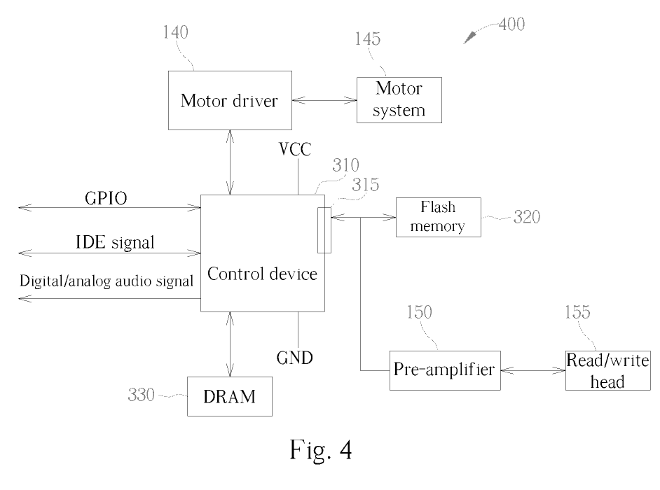

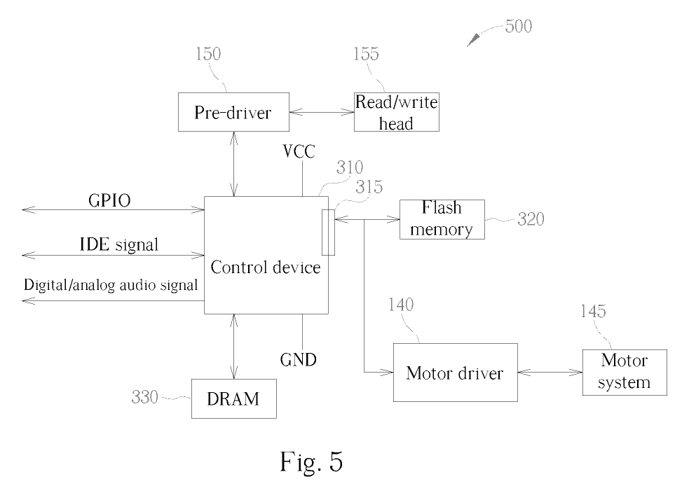

According to the above-mentioned embodiments, the idling mode communication interface 315 not only can be utilized as a general input/output port or can transmit/receive digital/analog audio signals and IDE signals, the communication interface 315 also can be utilized to connect other control circuits in the optical disc drive controlling system 300. Please refer to FIG. 4. FIG. 4 illustrates an embodiment of the control device 310. After completing accessing the flash memory 320, the control device 310 utilizes the communications interface 315 for controlling the pre-amplifier 150, meaning that the communications interface 315 connects the flash memory 320 and the pre-amplifier 150, instead of transmitting digital/analog audio signals and IDE signals, and instead of being utilized as the general input/output ports. Please also refer to FIG. 5. FIG. 5 illustrates an embodiment of the control device 310. After completing accessing the flash memory 320, the control device 310 utilizes the communications interface 315 to control the motor driver 140, meaning that the communication interface 315 connects the flash memory 320 and the motor driver 140.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical disc drive controlling system comprising:
a first memory for storing at least a program code; and
a control circuit for controlling operation of the optical disc drive controlling system, the control circuit comprising:
a communication interface coupled to the first memory for accessing the first memory; and
a second memory coupled to the control circuit;
wherein before storing the program code read from the first memory into the second memory, the control circuit transmits and receives signals related only to the operation of the first memory through the communication interface, and after storing the program code read from the first memory into the second memory, the control circuit transmits and outputs signals not related to the operation of the first memory through the communication interface.

2. The optical disc drive controlling system of claim 1, wherein the first memory is a non-volatile memory.

3. The optical disc drive controlling system of claim 2, wherein the non-volatile memory is a flash memory.

4. The optical disc drive controlling system of claim 1, wherein the second memory is a dynamic random access memory.

5. The optical disc drive controlling system of claim 1, wherein after storing the program code read from the first memory into the second memory, the control circuit outputs a digital audio signal through the communication interface.

6. The optical disc drive controlling system of claim 1, further comprising an electronic device coupled to the communication interface, wherein after storing the program code read from the first memory into the second memory, the control circuit controls the electronic device through the communication interface.

7. The optical disc drive controlling system of claim 1, wherein the control circuit further comprises a cache memory for caching a portion of the program code when the control circuit executes the program code stored in the second memory.

8. An optical disc drive controlling system, comprising:
a first memory for storing at least a program code;
a control circuit for controlling operation of the optical disc drive controlling system, the control circuit comprising:
a communication interface coupled to the first memory for accessing the first memory; and
a second memory coupled to the communication interface;
wherein after storing the program code read from the first memory into the second memory, the control circuit transmits and outputs signals which are related only to the operation of the second memory through the communication interface.

9. The optical disc drive controlling system of claim 8, wherein the second memory is a dynamic random access memory.

10. The optical disc drive controlling system of claim 8, wherein the first memory is a non-volatile memory.

11. The optical disc drive controlling system of claim 10, wherein the non-volatile memory is a flash memory.

12. The optical disc drive controlling system of claim 8, wherein the control circuit further comprises a cache memory, for caching a portion of the program code when the control circuit executes the program code stored in the second memory.

13. An optical disc drive controlling method comprising:
providing a control device with at least a pin;
providing a non-volatile memory, the non-volatile memory storing a program code and coupled to the control device through the pin;
providing a first logic circuit coupled to the control device through the pin;
transmitting at least a first signal between the control device and the non-volatile memory through the pin to read the program code stored in the non-volatile memory; and
transmitting at least a second signal between the control device and the first logic circuit through the pin after reading the program code.

14. The controlling method of claim 13, wherein the first logic circuit comprises a volatile memory, and the method further comprises:
loading the program code read from the non-volatile memory into the volatile memory; and
utilizing the control device to transmit the second signal through the pin to access the program code in the volatile memory.

15. The controlling method of claim 14, wherein the volatile memory is a dynamic random access memory.

16. The controlling method of claim 13, further comprising:
loading the program code read from the non-volatile memory into a volatile memory; and
utilizing the control device to access the program code in the volatile memory.

17. The controlling method of claim 16, wherein after the program code is read, the signal transmitted between the control device and the first logic circuit through the pin comprises at least one of a general purpose input/output (GPIO) signal, an IDE signal, and an audio signal.

18. The controlling method of claim 16, wherein the first logic circuit comprises a pre-amplifier.

19. The controlling method of claim 16, wherein the first logic circuit comprises a motor driver.

20. The controlling method of claim 13, wherein the non-volatile memory is a flash memory.
